(19) United States
(12) Patent Application Publication
(10) Pub. No.: US 2026/0213427 A1
(43) Pub. Date: Jul. 23, 2026

(54) BASE STATION ANTENNAS HAVING METAMATERIAL LENSES FOR IMPROVED PATTERNS AND ISOLATION

(71) Applicant: Outdoor Wireless Networks LLC, Richardson, TX (US)

(72) Inventors: Zeeshan Qamar, Melissa, TX (US); Chengcheng Tang, Murphy, TX (US); Peter J. Bisiules, LaGrange Park, IL (US)

(21) Appl. No.: 19/442,352

(22) Filed: Jan. 7, 2026

Related U.S. Application Data
(60) Provisional application No. 63/747,439, filed on Jan. 21, 2025.

(51) Int. Cl. H01Q 19/06; H01Q 1/24; H01Q 9/16; H01Q 21/06

(52) U.S. Cl. CPC H01Q 19/06; H01Q 1/246; H01Q 9/16; H01Q 21/06

(57) ABSTRACT

Base station antennas include a first RF port, a first array of first frequency band radiating elements, where each of the first frequency band radiating elements in the first array is coupled to the first RF port, and a first plurality of metamaterial RF lenses mounted forwardly of the first array, wherein each metamaterial RF lens comprises a plurality of unit cells, where at least two of the unit cells have different metallization patterns.

### CROSS REFERENCE TO RELATED APPLICATION

The present application claims priority to U.S. Provisional Patent Application Ser. No. 63/747,439, filed Jan. 21, 2025, the entire content of which is incorporated herein by reference as if set forth in its entirety.

### FIELD

The present invention generally relates to radio communications and, more particularly, to base station antennas utilized in cellular and other communications systems.

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. Most cells are divided into a plurality of “sectors,” and separate base station antennas provide coverage to each of the sectors. The base station antennas are often mounted on a tower or other raised structure, with the radiation pattern (“antenna beam”) that is generated by each antenna directed outwardly to serve a respective sector. Typically, a base station antenna includes one or more phase-controlled arrays of radiating elements, with the radiating elements arranged in one or more vertical columns when the antenna is mounted for use. A vertically-extending column of radiating elements that is coupled to a single radio port (or to two radio ports if the radiating elements are dual polarization radiating elements) is typically referred to as a “linear array” of radiating elements. Herein, “vertical” refers to a direction that is generally perpendicular relative to the plane defined by the horizon. References will also be made herein to the “azimuth” and “elevation” planes. The azimuth plane refers to a horizontal plane that bisects the base station antenna that is parallel to the plane defined by the horizon. The elevation plane refers to a plane that is perpendicular to the azimuth plane that bisects the front surface of the base station antenna.

When an RF signal is fed from a radio port to the radiating elements in a linear array, the RF energy is radiated into free space through the radiating elements, generating the antenna beam. Most base station antennas include linear arrays that are formed using dual polarization radiating elements. A dual polarization radiating element refers to a radiating element that has first and second radiators that transmit/receive RF signals at orthogonal polarizations. The use of dual polarization radiating elements allows the number of antenna beams generated by a linear array to be doubled as compared to an antenna that uses single polarization radiating elements, typically with only a minimal increase in the size of the antenna. The shape of each antenna beam generated by a linear array is defined by, among other things, the characteristics of the individual radiating elements, the characteristics of the linear array (e.g., the spacing between adjacent radiating elements) and by the magnitudes and phases of the sub-components of the RF signal that are fed to each individual radiating element in the linear array. Antenna beams are often characterized by their Half Power Beam Width (“HPBW”) in the azimuth and elevation planes. The HPBW refers to the number of degrees in the designated plane where the radiated power of a main lobe of the antenna beam is within 3 dB (50%) of the peak power of the antenna beam.

A common base station configuration is a “three sector” configuration in which a cell is divided into three 120° sectors in the azimuth plane, and the base station includes three base station antennas that provide coverage to the three respective sectors. In a three sector configuration, the antenna beams generated by each base station antenna typically have a HPBW in the azimuth plane of about 65°, as such an antenna beam may provide good coverage throughout a 120° sector without having significant RF energy spill over into the other two sectors.

Cellular communications are primarily performed in three different frequency ranges, which are commonly referred to as the “low-band,” “mid-band” and “high-band” frequency ranges. The low-band frequency range is generally defined as the 696-960 MHz frequency range (or more recently as the 617-960 MHz frequency range). The mid-band frequency range is generally defined as the 1695-2690 MHz frequency range (or, more recently as the 1427-2690 MHz frequency range). The high-band frequency range is more variable in nature, but may include different ranges of frequencies in the 3.1-5.8 GHz frequency range. Cellular operators are licensed to use small sub-bands in each of these frequency ranges, where the sub-bands will vary with geographic location and operator. Consequently, particularly for the low-band and mid-band frequency ranges, base station antennas typically include linear arrays that support service across the full low-band and mid-band frequency ranges so that the antennas can be used by any operator in any geographic location.

There is significant interest in base station antennas that include two or more linear arrays of radiating elements that support service in the same frequency band, since such base station antennas can support service in two sub-bands of the frequency band and/or support 4xMIMO communications, where MIMO stands for “multi-input-multi-output. The term ZxMIMO refers to a communication technique where a baseband data stream is sub-divided into Z sub-streams (where Z is a positive integer greater than 1) that are used to generate Z RF signals that are transmitted through multiple different arrays of radiating elements (and/or by the different polarization radiators in a linear array). The different arrays are, for example, spatially separated from one another and/or at orthogonal polarizations so that the transmitted RF signals will be sufficiently decorrelated. The Z RF signals are recovered at the receiver and demodulated and decoded to recover the original Z data sub-streams, which are then recombined. The use of MIMO transmission techniques may help overcome the negative effects of multipath fading, and may be particularly effective in urban environments where reflections may increase the level of decorrelation between the RF signals.

Unfortunately, it can be challenging to implement base station antennas that have two or more arrays of low-band radiating elements in a commercially acceptable manner. The size of a radiating element is inversely correlated with its frequency of operation, and hence the low-band radiating elements are usually the largest radiating elements in a base station antenna. As such, providing an antenna that includes two arrays of low-band radiating elements often results in an antenna having a width exceeding 500 mm, which is undesirable.

FIG. 1 is a schematic front view of a conventional base station antenna 1 (with the radome thereof removed) that illustrates the difficulty of providing a narrow width base station antenna that includes two linear arrays of low-band radiating elements.

As shown in FIG. 1, base station antenna 1 includes first and second linear arrays 20-1, 20-2 of dual polarization low-band radiating elements 22. Herein, when multiple of the same elements are included in an antenna, the elements may be referred to individually by their full reference numeral (e.g., linear array 20-2) and collectively by the first part of their reference numerals (e.g., the linear arrays 20). All of the radiating elements in each linear array 20 are connected to a common RF port of base station antenna 1 (or to two RF ports if dual polarization radiating elements are used). Each low-band linear array 20-1, 20-2 comprises a vertically-extending column of low-band radiating elements 22. It should be noted that the radiating elements in a linear array are sometimes staggered to a degree in the horizontal direction, which can reduce the azimuth HPBW of the antenna beams generated by the linear array. Such arrays are still considered to be “linear arrays” for purposes of the present disclosure even though the radiating elements are not all aligned along a vertical axis. As further shown in FIG. 1, the base station antenna 1 typically also includes four linear arrays 30-1 through 30-4 of mid-band radiating elements 32. The mid-band radiating elements 32 are smaller than the low-band radiating elements and hence can be mounted behind the low-band radiating elements 22 with little or no increase in the width of the base station antenna 1. Base station antenna 1 further includes eight mid-band RF ports 36-1 through 36-8. Each mid-band linear array 30 is coupled to a pair of the mid-band RF ports 32 (one port for each polarization).

As shown in FIG. 1, the low-band and mid-band linear arrays 120, 130 each extend in a longitudinal direction L, and are spaced apart from one another in a transverse direction T that is perpendicular to the longitudinal direction L. The low-band and mid-band radiating elements 22, 32 are mounted to extend from a reflector 10 in a forward direction F that is perpendicular to both the longitudinal direction L and the transverse direction T.

Each low-band radiating element 22 is schematically shown using an “X” to indicate that the low-band radiating elements 22 are implemented as slant −45°/+45° cross-dipole radiating elements that each include a first dipole radiator 24-1 that transmits and receives RF radiation having a slant −45° linear polarization and a second dipole radiator 24-2 that transmits and receives RF radiation having a slant +45° linear polarization. The first dipole radiator 24-1 of each low-band radiating element 22 in the first linear array 20-1 is coupled to a first low-band RF port 26-1 through a first feed network (not shown), and the second dipole radiator 24-2 of each low-band radiating element 22 in the first linear array 20-1 is coupled to a second low-band RF port 26-2 through a second feed network (not shown). Thus, RF signals input at RF port 26-1 are passed to the first dipole radiators 24-1 of the radiating elements 22 of the first low-band linear array 20-1 where they are emitted into free space to generate a first low-band antenna beam (having a +45° polarization), and RF signals input at RF port 26-2 are passed to the second dipole radiators 24-2 of the radiating elements 22 of the first low-band linear array 20-1 to generate a second low-band antenna beam (having a −45° polarization). The second low-band linear array 20-2 is coupled to the third and fourth low-band RF ports 26-3, 26-4 in the same manner and hence can generate third and fourth low-band antenna beams. The mid-band radiating elements may also be implemented as slant −45°/+45° cross-dipole radiating elements.

Base station antennas having the design of base station antenna 1 typically have a large width, which increases the weight of the antenna 1 and the wind loading thereon. While the width of base station antenna 1 could be reduced by decreasing the lateral spacing between the linear arrays 20-1, 20-2, spacing the low-band linear arrays 20-1, 20-2 closer together acts to increase the degree of signal coupling between the linear arrays 20-1, 20-2 and this “parasitic” coupling can itself lead to an undesired increase in the azimuth HPBW. Moreover, in many cases the size of each low-band radiating element 22 is reduced as much as possible to decrease the width of the base station antenna, but the smaller low-band radiating elements 22 have larger azimuth HPBWs and thus the generated antenna beams will tend to have reduced gain and/or spill over into neighboring sectors. Consequently, it may be difficult to provide base station antennas that have two or more arrays of low-band radiating elements in a commercially acceptable manner.

### SUMMARY

Pursuant to embodiments of the present invention, base station antennas are provided that comprise a first RF port, a first array of first frequency band radiating elements, where each of the first frequency band radiating elements in the first array is coupled to the first RF port, and a first plurality of metamaterial RF lenses mounted forwardly of the first array, wherein each metamaterial RF lens comprises a plurality of unit cells, where at least two of the unit cells have different metallization patterns.

In some embodiments, the base station antenna may further comprise a reflector, and radiators of the respective first frequency band radiating elements in the first array may be positioned forwardly of the reflector. In some embodiments, the unit cells that extend around a periphery of a first of the metamaterial RF lenses are configured to impart a larger average phase change to first frequency band RF radiation incident thereto than are the unit cells that are within the periphery of the first of the metamaterial RF lenses. In some embodiments, the unit cells of a first of the metamaterial RF lenses are arranged in rows and columns. In some embodiments, the unit cells of the first of the metamaterial RF lenses are arranged asymmetrically.

In some embodiments, each metamaterial RF lens comprises a planar structure. In some embodiments, the base station antenna may further comprise a second RF port and a second array of first frequency band radiating elements, where each of the first frequency band radiating elements in the second array is coupled to the second RF port. In such embodiments, the first array and the second array may have respective longitudinal axes that each extend in a longitudinal direction, and may be spaced apart from each other in a transverse direction that is perpendicular to the longitudinal direction and to a forward direction. In some embodiments, the unit cells of the first of the metamaterial RF lenses are arranged asymmetrically about a first longitudinal axis and/or about a first transverse axis.

In some embodiments, the base station antenna may further comprise a second plurality of metamaterial RF lenses that are mounted forwardly of the second array. In some embodiments, the unit cells in a first column of unit cells of the first of the metamaterial RF lenses that is closest to the second array of first frequency band radiating elements are configured to impart a larger average phase change to first frequency band RF radiation incident thereto than are the remaining unit cells of the first of the metamaterial RF lenses.

In some embodiments, the metamaterial RF lenses in the first plurality of metamaterial RF lenses are formed in a single printed circuit board as a monolithic structure.

In some embodiments, each metamaterial RF lens in the first plurality of metamaterial RF lenses is formed in a respective one of a plurality of printed circuit boards.

In some embodiments, the base station antenna further comprises a third array of second frequency band radiating elements, and the metamaterial RF lens in the first plurality of metamaterial RF lenses are configured to be substantially transparent to RF radiation at the highest frequency in the second frequency band.

In some embodiments, a first subset of the unit cells of a first of the metamaterial RF lenses that overlap the radiators of a first of the first frequency band radiating elements in a forward direction are configured to impart a larger average phase change to first frequency band RF radiation incident thereto than are the remaining unit cells of the first of the metamaterial RF lenses.

In some embodiments, each unit cell of the first of the metamaterial RF lenses comprises a plurality of arcuate metal traces that define a respective circular ring. In some embodiments, at least some of the unit cells of the first of the metamaterial RF lenses comprise a plurality of meandered metal traces. In some embodiments, the plurality of meandered metal traces of each of the at least some of the unit cells of the first of the metamaterial RF lenses extend inwardly from the respective circular rings.

In some embodiments, the unit cells in a first column of unit cells of the first of the metamaterial RF lenses that is closest to the second array of first frequency band radiating elements include, on average, more metal than do the remaining unit cells of the first of the metamaterial RF lenses.

In some embodiments, at least some of the unit cells of the first of the metamaterial RF lenses comprise a plurality of meandered metal traces, and wherein the meandered traces of the unit cells in a first column of unit cells of the first of the metamaterial RF lenses that is closest to the second array of first frequency band radiating elements are longer, on average, than are the meandered traces in the remaining unit cells of the first of the metamaterial RF lenses.

In some embodiments, each unit cell of the first of the metamaterial RF lenses comprises one or more arcuate metal traces, the arcuate metal traces of each unit cell of the first of the metamaterial RF lenses defining a respective circular ring, wherein at least some of the unit cells of the first of the metamaterial RF lenses comprise a plurality of meandered metal traces that extend inwardly from the respective circular rings, and wherein the meandered traces of the unit cells in a first column of unit cells of the first of the metamaterial RF lenses that is closest to the second array of first frequency band radiating elements extend, on average, closer to the centers of the respective circular rings than do the meandered traces in the remaining unit cells of the first of the metamaterial RF lenses.

Pursuant to embodiments of the present invention, base station antennas are provided that comprise a first RF port, a first array of first frequency band radiating elements, where each of the first frequency band radiating elements in the first array is coupled to the first RF port, and a first metamaterial RF lens that comprises a plurality of unit cells mounted forwardly of a first of the first frequency band radiating elements in the first array. The unit cells that extend around a periphery of the first metamaterial RF lens are configured, on average, to impart a larger phase change to first frequency band RF radiation incident thereto than are the unit cells that are within the periphery of the first metamaterial RF lens.

In some embodiments, the base station antenna further comprises a reflector, wherein radiators of the respective first frequency band radiating elements in the first array are positioned forwardly of the reflector. In some embodiments, the base station antenna further comprises a second RF port and a second array of first frequency band radiating elements, where each of the first frequency band radiating elements in the second array is coupled to the second RF port. In these embodiments, the first array and the second array have respective longitudinal axes that extend in a longitudinal direction, and are spaced apart from each other in a transverse direction that is perpendicular to the longitudinal direction. In some embodiments, the unit cells of the first metamaterial RF lens are arranged in a plurality of rows that extend in the transverse direction and in a plurality of columns that extend in the longitudinal direction. In some embodiments, the unit cells in a first of the plurality of columns that is a closest of the plurality of columns to the second array are configured to, on average, impart a larger phase change to first frequency band RF radiation incident thereto than are the unit cells in a second of the plurality of columns that is a farthest of the plurality of columns from the second array.

In some embodiments, the first metamaterial RF lens comprises a printed circuit board that has a dielectric substrate and wherein each unit cell includes metallization on both sides of the dielectric substrate. In some embodiments, the unit cells are arranged asymmetrically about a first longitudinal axis.

In some embodiments, the base station antenna further comprises a second metamaterial RF lens that comprises a plurality of unit cells mounted forwardly of one of the first frequency band radiating elements in the second array.

In some embodiments, the second metamaterial RF lens is identical to the first metamaterial RF lens. In some embodiments, the second metamaterial RF lens is rotated 180 degrees with respect to the first metamaterial RF lens.

In some embodiments, each unit cell of the first metamaterial RF lens comprises a plurality of arcuate metal traces that define a respective circular ring. In some embodiments, at least some of the unit cells of the first metamaterial RF lens comprise a plurality of meandered metal traces. In some embodiments, the plurality of meandered metal traces of each of the at least some of the unit cells of the first metamaterial RF lens extend inwardly from the respective circular rings.

In some embodiments, the unit cells in a first column of unit cells of the first metamaterial RF lens that is closest to the second array of first frequency band radiating elements include, on average, more metal than do the remaining unit cells of the first metamaterial RF lens.

Pursuant to embodiments of the present invention, base station antennas are provided that comprise a first RF port, a second RF port, a first array of first frequency band radiating elements, where each of the first frequency band radiating element in the first array is coupled to the first RF port, a first metamaterial RF lens mounted forwardly of a first of the first frequency band radiating elements in the first array, and a second array of first frequency band radiating elements, where each of the first frequency band radiating elements in the second array is coupled to the second RF port. The first metamaterial RF lens is configured to increase isolation between the first array and the second array.

In some embodiments, the base station antenna further comprises a second metamaterial RF lens mounted forwardly of a first of the first frequency band radiating elements in the second array, wherein the second metamaterial RF lens is configured to increase isolation between the first array and the second array.

In some embodiments, the first metamaterial RF lens comprises a plurality of unit cells, and ones of the unit cells that extend around a periphery of the first metamaterial RF lens are configured to impart a larger average phase change to first frequency band RF radiation incident thereto than are the unit cells that are within the periphery of the first metamaterial RF lens.

In some embodiments, the first metamaterial RF lens comprises a plurality of unit cells, and ones of the unit cells of the first metamaterial RF lens are arranged in a plurality of rows and in a plurality of columns. In some embodiments, the unit cells of the first metamaterial RF lens have an asymmetrical arrangement.

In some embodiments, the unit cells in a first of the plurality of columns that is a closest of the plurality of columns to the second array are, on average, configured to impart a larger phase change to first frequency band RF radiation incident thereto than are the remaining unit cells of the first metamaterial RF lens.

In some embodiments, each unit cell of the first metamaterial RF lens comprises a plurality of arcuate metal traces that define a respective circular ring. In some embodiments, at least some of the unit cells of the first metamaterial RF lens comprise a plurality of meandered metal traces. In some embodiments, the plurality of meandered metal traces of each of the at least some of the unit cells of the first metamaterial RF lens extend inwardly from the respective circular rings.

In some embodiments, the unit cells in a first column of unit cells of the first metamaterial RF lens that is closest to the second array of first frequency band radiating elements include, on average, more metal than do the remaining unit cells of the first metamaterial RF lens.

Pursuant to embodiments of the present invention, base station antennas are provided that comprise a reflector, a first RF port, a first array of first frequency band radiating elements, where the first array extends in a longitudinal direction and each of the first frequency band radiating elements in the first array is coupled to the first RF port, a second RF port, a second array of first frequency band radiating elements, where the second array extends in the longitudinal direction and is spaced apart from the first array in a transverse direction that is perpendicular to the longitudinal direction, and where each of the first frequency band radiating elements in the second array is coupled to the first RF port, and a metamaterial RF lens that comprises a plurality of unit cells mounted forwardly of a first of the first frequency band radiating elements in the first array, the metamaterial RF lens overlapping the first of the first frequency band radiating elements in a forward direction that is perpendicular to both the longitudinal direction and the transverse direction. A first subset of the unit cells of the metamaterial RF lens that overlap dipole radiators of the first of the first frequency band radiating elements in the forward direction include a greater amount of metal, on average, than are the remaining unit cells of the metamaterial RF lens.

In some embodiments, at least some of the unit cells in the first subset of the unit cells comprise meandered traces.

In some embodiments, a first subset of the unit cells of the metamaterial RF lens that overlap the dipole radiators of a first of the first frequency band radiating elements in the forward direction are configured to impart a larger average phase change to first frequency band RF radiation incident thereto than are the remaining unit cells of the metamaterial RF lens.

Pursuant to embodiments of the present invention, base station antennas are provided that comprise a first RF port, a second RF port, a first array of first frequency band radiating elements, where each of the first frequency band radiating element is coupled to the first RF port, a second array of second frequency band radiating elements, where each of the second frequency band radiating elements is coupled to the second RF port, and a metamaterial RF lens mounted forwardly of a first of the first frequency band radiating elements. The metamaterial RF lens is configured to reduce a half power azimuth beamwidth of an antenna beam generated by the first array and is configured to be substantially transparent to RF radiation at a highest frequency in the second frequency band.

In some embodiments, at least some of the unit cells comprise meandered traces.

### BRIEF DESCRIPTION OF THE DRAWINGS

FIG. 1 is a schematic front view of a conventional base station antenna (with the radome removed) that includes two linear arrays of low-band radiating elements and four linear arrays of mid-band radiating elements.

FIG. 2A is a perspective view of a base station antenna according to embodiments of the present invention.

FIG. 2B is a schematic perspective view of the base station antenna of an antenna assembly of the base station antenna of FIG. 2A.

FIG. 2C is a schematic front view of the antenna assembly of FIG. 2B with the metamaterial RF lenses shown in shadow view to better show the linear arrays of radiating elements.

FIG. 2D is an enlarged front view of one of the metamaterial RF lenses that is included in the base station antenna of FIGS. 2A-2C.

FIGS. 2E-2G are enlarged views of the three different unit cells included in the metamaterial RF lens of FIG. 2D.

FIG. 3A is a graph illustrating the insertion loss as a function of frequency for each of the three unit cells shown in FIGS. 2E-2G.

FIG. 3B is a graph illustrating the phase change as a function of frequency imparted by each of the three unit cells shown in FIGS. 2E-2G.

FIGS. 4A and 4B are front views of asymmetric aperiodic metamaterial RF lens according to further embodiments of the present invention.

FIG. 4C is a schematic front view of a small portion of a base station antenna according to embodiments of the present invention that includes a plurality of the asymmetric aperiodic metamaterial RF lenses of FIG. 4A.

FIG. 5 is a schematic front view of an aperiodic metamaterial RF lens according to still further embodiments of the present invention.

FIGS. 6A-6C are graphs that illustrate the simulated phase responses along three different planes for a single low-band radiating element of a base station antenna that does not include any metamaterial RF lenses.

FIG. 6D is a schematic front view of the base station antenna that illustrates the planes of the three cut lines corresponding to FIGS. 6A-6C.

FIGS. 7A-7C are graphs that illustrate the simulated phase responses along the same three planes used to generate the graphs of FIGS. 6A-6C for a single low-band radiating element of a base station antenna that includes metamaterial RF lenses.

FIG. 8 is a table that compares the standard deviation of the phase responses shown in FIGS. 6A-6C (baseline) to the corresponding phase responses shown in FIGS. 7A-7C (AML).

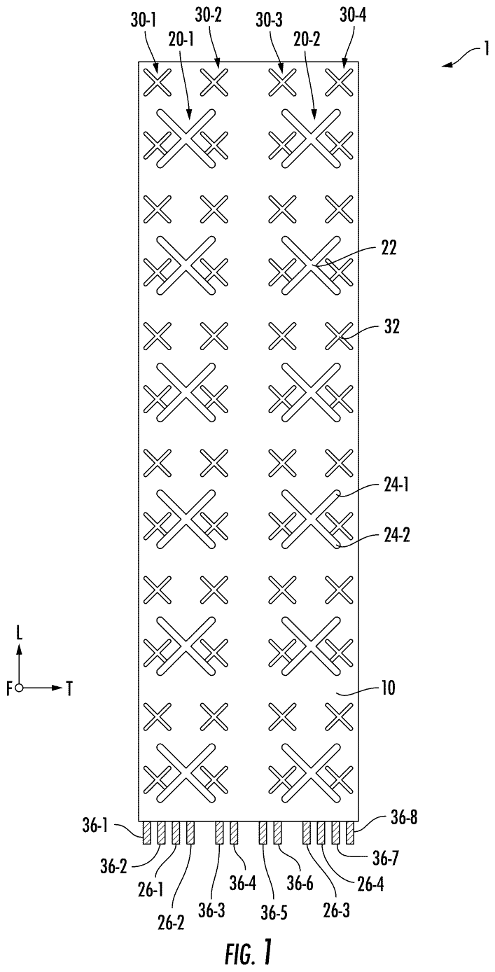

### DETAILED DESCRIPTION

As discussed above, base station antennas that include two linear arrays of low-band radiating elements tend to be overly wide, as the physical size of the low-band radiating elements is large. While it is often possible to shrink the size of the low-band radiating elements to an extent, which allows a reduction in the width of the antenna, the smaller low-band radiating elements generate individual antenna beams having larger azimuth HPBWs. Antenna beams having larger azimuth HPBWs tend to exhibit lower antenna gains and have increased interference with neighboring sectors. Another way to decrease the width of a base station antenna that includes two low-band linear arrays of low-band radiating elements is to decrease the separation between the two low-band linear arrays. This, however, results in increased coupling between the two low-band linear arrays, which can distort the antenna beams generated by the two low-band linear arrays (typically by increasing the azimuth HPBW by “pulling” radiation emitted by each low-band linear array in the direction of the other low-band linear array), decrease co-polarization isolation, decrease cross-polarization isolation and decrease self-isolation.

One way to decrease the coupling between two closely spaced-apart linear arrays of low-band radiating elements is to place a metal isolation wall between the two low-band linear arrays. The metal isolation wall can significantly reduce the coupling between the two linear arrays, and hence the above-described adverse effects of decreasing the spacing between the two linear arrays can be partially alleviated through the use of the metal isolation wall. However, if the base station antenna includes linear arrays of mid-band radiating elements (which is almost always the case), then the metal isolation wall acts to partially block the radiation emitted by the smaller mid-band radiating elements, significantly disrupting the shape of the mid-band antenna beams. Moreover, strong low-band currents may flow on the metal isolation wall in response to RF emission by the low-band radiating elements, and these currents result in additional low-band radiation (i.e., the isolation wall acts as a parasitic element) that acts to broaden the azimuth HPBW of the antenna beams generated by the low-band linear arrays.

Pursuant to embodiments of the present invention, base station antennas are provided that include aperiodic metamaterial RF lenses that are used to focus the antenna beams emitted by one or more arrays of radiating elements included in the antenna. These metamaterial RF lenses may be implemented on printed circuit boards in some embodiments, with each metamaterial RF lens being positioned forwardly of the radiator(s) of a respective one of the radiating elements in the one or more arrays. The metamaterial RF lenses may be thin (e.g., have a thickness of about 20 mm or less in some embodiments, and less than 5 mm or even less than 3 mm in some embodiments) and may be positioned close to the radiating elements (e.g., within 15 mm and/or within 0.05 of a wavelength of the radiators of the radiating elements). The metamaterial RF lens according to embodiments of the present invention may focus the antenna beams emitted by a linear array in both the azimuth and elevation planes, thereby increasing the directivity of the antenna beams. The metamaterial RF lens may be designed so that they introduce only a small increase in the insertion loss, and the metamaterial RF lens may exhibit good impedance matching with the radiators of the radiating elements so that the return loss may be low over a wide frequency range. Thus, the metamaterial RF lens according to embodiments of the present invention may provide increased gain reduced azimuth beamwidths, both of which are desired by cellular network operators.

The metamaterial RF lens according to some embodiments of the present invention may be designed to reduce coupling between two side-by-side same frequency band arrays of radiating elements. As discussed above, cellular network operators often deploy base station antennas having two linear arrays of low-band radiating elements. In order to reduce the widths of these antennas, and hence the wind loading, the two low-band linear arrays are often in close proximity to each other, with the gap between adjacent radiating elements in the two arrays being as little as 0.6 of a wavelength corresponding to the center frequency of the operating frequency band of the radiating elements in the two arrays. Unfortunately, when the two low-band linear arrays are in close proximity to each other, some of the RF radiation emitted by the radiating elements in a first of the arrays will couple to the dipole arms of the radiating elements in the second array, which results in RF currents forming on the dipole arms. These RF currents emit RF radiation. The net effect is that some of the RF radiation emitted by the first array ends up being re-radiated by radiating elements of the second array, which may negatively impact the shape and directivity of the antenna beams emitted by the first array.

The metamaterial RF lenses according to embodiments of the present invention may focus the RF energy emitted by their associated radiating elements by adjusting the phase of the RF radiation that passes through the metamaterial RF lenses. The metamaterial RF lenses may have an aperiodic unit cell design so that different unit cells can impart different amounts of phase change on the RF radiation that passes through the metamaterial RF lenses. The differential phase shifts that are applied to the RF radiation passing through different unit cells of the metamaterial RF lenses may be designed to focus the RF energy, thereby decreasing the azimuth and/or elevation beamwidths of the generated antenna beams.

The metamaterial RF lenses according to embodiments of the present invention may also act to improve the isolation between the two arrays in the above-discussed example. In some embodiments the metamaterial RF lens may be designed to impart greater amounts of phase change to RF energy that is emitted at larger angles away from the boresight pointing direction of an associated linear array. While not wanting to be bound to any theory of operation, the outer unit cells of the metamaterial RF lenses that impart larger phase changes may more heavily redirect the RF radiation toward the boresight pointing direction, and hence away from an adjacent array. It is believed that this effect tends to increase the isolation between the two side-by-side arrays.

In some embodiments, the metamaterial RF lens may not only have an aperiodic unit cell design, but may also have an asymmetric unit cell design. For example, the unit cell patterns on the left and right sides of a metamaterial RF lens may be designed to be different so that one of the sides will exhibit a higher amount of focusing in order to increase the isolation between the two arrays. Adding a metamaterial RF lens to a base station antenna involves performance tradeoffs, as the greater the focusing of the RF energy (which is desired for increased directivity) and the closer the lenses are to the radiating elements (which is desired to reduce the size of the base station antenna), the more the insertion loss of the metamaterial RF lens increases and the operating bandwidth of the array decreases. By using an asymmetric lens design, the lenses may be designed to more heavily focus the RF radiation incident on one side of the lens than the other in order to leverage the fact that enhanced focusing on the sides of the lenses that are adjacent another same frequency band array may have the additional benefit of increased intra-array isolation.

In some embodiments, the unit cells of the metamaterial RF lens according to embodiments of the present invention may be designed to be cloaked with respect to RF energy in one or more other frequency bands. As a result, the metamaterial RF lens will focus RF energy in a first frequency band, but will be substantially transparent to RF energy in a second, different and non-overlapping frequency band. Such a design may ensure that the metamaterial RF lens do not negatively impact the antenna beams generated by other frequency band arrays included in the base station antenna. Herein, the term “substantially transparent” means that the return loss and isolation performance of the other frequency band arrays vary by less than 5% when the metamaterial RF lenses are added, and that the azimuth 3 dB beamwidth and sector power ratio of the antenna beams generated by the other frequency band arrays vary by less than 5% when the metamaterial RF lenses are added.

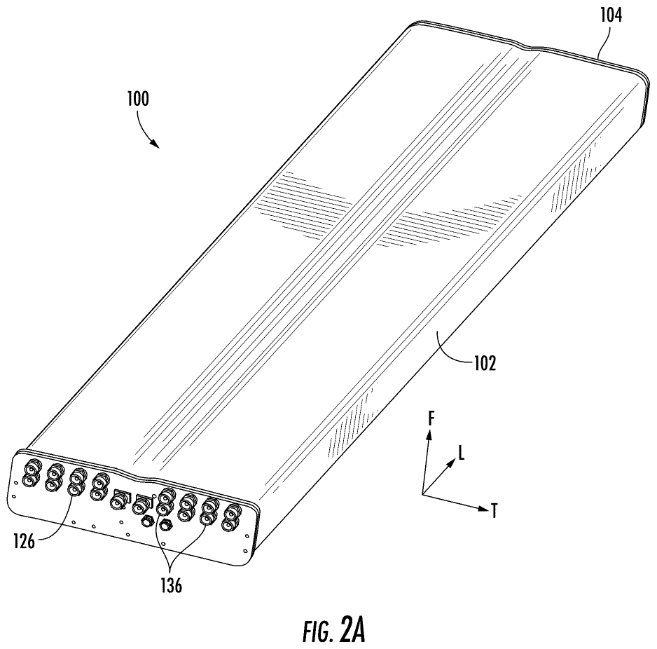

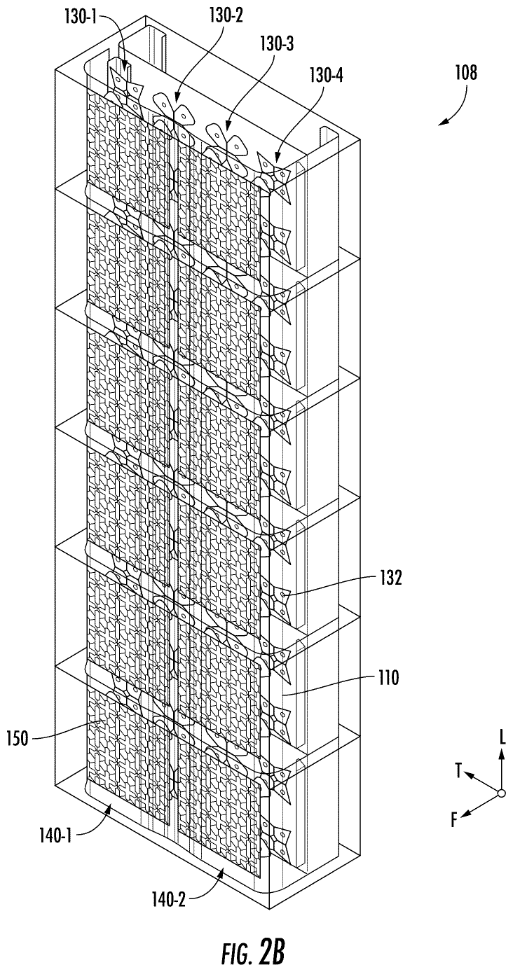

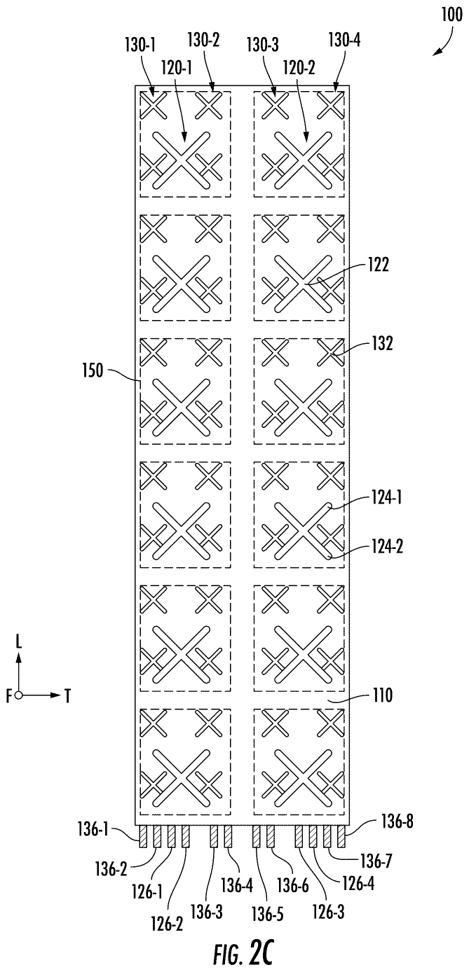

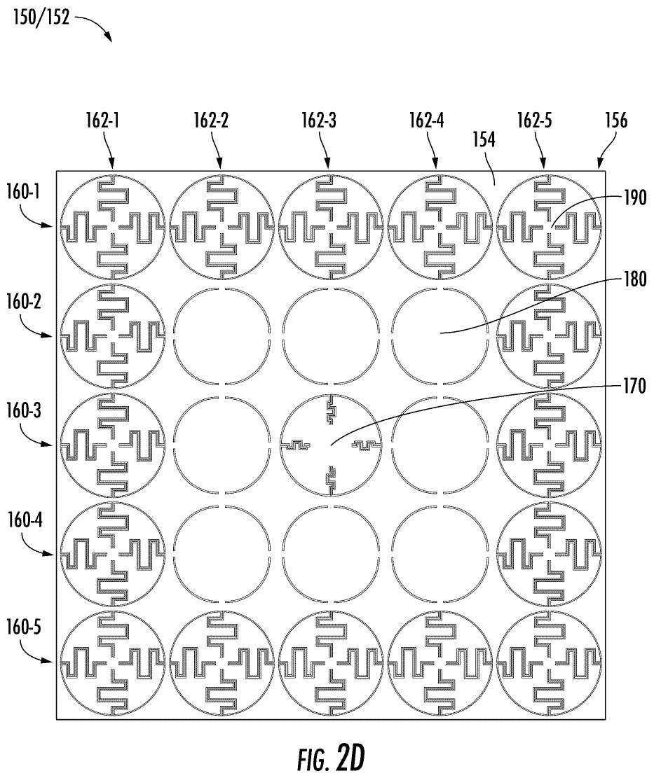

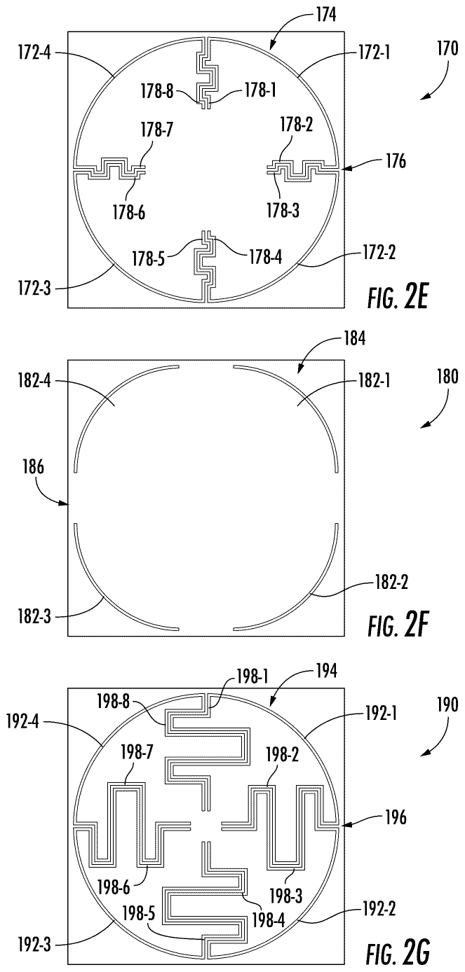

Embodiments of the present invention will now be discussed in more detail with reference to FIGS. 2A-5.

As discussed above, it can be difficult to reduce the width of base station antennas that include two arrays of low-band radiating elements while maintaining good performance. Pursuant to embodiments of the present invention, relatively narrow base station antennas are provided that include two linear arrays of low-band radiating elements that exhibit good performance. FIGS. 2A-2G illustrate one such base station antenna 100 according to embodiments of the present invention.

Referring first to FIG. 2A, a perspective view of the base station antenna 100 is provided. As shown in FIG. 2A, the base station antenna 100 is an elongated structure that extends along a longitudinal axis L. The base station antenna 100 may have a tubular shape with a generally rectangular cross-section. The base station antenna 100 includes a radome 102 and a top end cap 104. The base station antenna 100 also includes a bottom end cap 106 which includes a plurality of RF connectors 126, 136 mounted therein. The base station antenna 100 is typically mounted in a vertical configuration (i.e., the longitudinal axis L may be generally perpendicular to a plane defined by the horizon when the base station antenna 100 is mounted for normal operation).

FIG. 2B is a schematic perspective view of the base station antenna 100 of FIG. 2A with the radome 102 and end caps 104, 106 removed to illustrate an antenna assembly 108 of base station antenna 100. FIG. 2C is a schematic front view of the antenna assembly 108 with the metamaterial RF lenses shown in shadow view to show the radiating elements and metamaterial RF lenses that are included in base station antenna 100. In FIG. 2B the radiating elements are illustrated by “X” shapes to simplify the drawing. Sets of axes are provided in FIGS. 2B-2C that illustrates the longitudinal L, transverse T and forward F directions of base station antenna 100.

As shown in FIGS. 2B-2C, base station antenna 100 includes first and second linear arrays 120-1, 120-2 of low-band radiating elements 122 and first through fourth linear arrays 130-1 through 130-4 of mid-band radiating elements 132. The low-band radiating elements 122 and the mid-band radiating elements 132 each extend forwardly from a reflector 110. The reflector 110 may comprise a sheet of metal that serves as a ground plane for the radiating elements 122, 132 and may redirect backwardly emitted radiation from the radiating elements 122, 132 in the forward direction F.

Each linear array 120, 130 may extend along a respective axis that extends in the longitudinal direction L. Since base station antenna 100 will typically extend substantially vertically with respect to a horizontal plane defined by the horizon when the base station antenna 100 is mounted for use, the low-band and mid-band linear arrays 120, 130 may each be vertically-extending columns of radiating elements. The low-band and mid-band linear arrays 120, 130 may be spaced apart from each other in the transverse direction T. Each low-band radiating element 122 in the first linear array 120-1 is aligned in the transverse direction T with a respective one of the low-band radiating elements 122 in the second linear array 120-2 so that the antenna 100 has a plurality of rows (here six rows) of low-band radiating elements 122, where each row has two low-band radiating elements 122 therein.

Each low-band radiating element 122 may be configured to operate in some or all of the 617-960 MHz “low-band” frequency range. Typically, the low-band radiating elements 122 will be configured to operate in either the full 617-960 MHz frequency range or in the 694-960 MHz frequency range. Each low-band radiating element 122 may be a dual-polarization radiating element such as, for example, a center-fed slant −/+45° cross dipole radiating element that has a first dipole radiator 124-1 that is configured to transmit and receive slant +45° polarization RF radiation and a second dipole radiator 124-2 that is configured to transmit and receive slant −45° polarization RF radiation. Each mid-band radiating element 132 may be configured to operate in some or all of the 1427-2690 MHz “mid-band” frequency range. Each mid-band radiating element 132 may be a dual-polarization radiating element such as, for example, a center-fed slant −/+45° cross dipole radiating element. Typically, the mid-band radiating elements 132 will be configured to operate in either the full 1427-2690 MHz frequency range or in the 1695-2690 MHz frequency range.

The base station antenna 100 further includes first through fourth low-band RF ports 126-1 through 126-4 and first through eighth mid-band RF ports 136-1 through 136-8. Each RF port 126, 136 may have a connector interface that allows the RF port 126, 136 to connect to a port of an external radio (e.g., via a coaxial cable). Each low-band RF port 126 is connected to a respective low-band feed network (not shown). In particular, the first low-band feed network electrically connects the first RF port 126-1 to the first polarization (+45°) dipole radiators 124-1 of the radiating elements 122 in the first low-band linear array 120-1, the second low-band feed network electrically connects the second RF port 126-2 to the second polarization (−45°) dipole radiators 124-2 of the radiating elements 122 in the first low-band linear array 120-1, the third low-band feed network electrically connects the third RF port 126-3 to the first polarization (+45°) dipole radiators 124-1 of the radiating elements 122 in the second low-band linear array 120-2, and the fourth low-band feed network electrically connects the fourth RF port 126-4 to the second polarization (−45°) dipole radiators 124-2 of the radiating elements 122 in the second low-band linear array 120-2. Eight mid-band feed networks (not shown) are similarly provided that connect each mid-band RF port 136 to either the first polarization dipole radiators or the second polarization dipole radiators of one of the mid-band linear arrays 130. The low-band and/or mid-band feed networks may also include respective electromechanical phase shifters that may impart an adjustable phase progression to the sub-components of the RF signals that are fed to the individual dipole radiators in order to apply an electrical downtilt to the antenna beams generated by the base station antenna 100 in response to RF signals input at each RF port 126, 136.

Still referring to FIG. 2B, base station antenna 100 further includes a first array 140-1 of metamaterial RF lenses 150 and a second array 140-2 of metamaterial RF lenses 150. The metamaterial RF lenses 150 of the first array 140-1 are positioned forwardly of the first linear array 120-1 of low-band radiating elements 122, and the metamaterial RF lenses 150 of the second array 140-2 are positioned forwardly of the second linear array 120-2 of low-band radiating elements 122. The metamaterial RF lenses 150 are designed to focus the antenna beams generated by the low-band linear arrays 120-1, 120-2 in the azimuth and/or elevation planes. This may advantageously increase the directivity and sector power ratio of the low-band linear arrays 120, and may also reduce the degree to which the low-band linear arrays 120 have RF energy spill over into neighboring sectors, where the RF radiation will appear as interference. Moreover, as will be discussed in greater detail below, the metamaterial RF lenses 150 may also advantageously increase the degree of isolation between the two low-band linear arrays 120-1, 120-2.

Metamaterial RF lenses are known in the art, and are formed as a plurality of unit cells. Metamaterial RF lenses operate using Huygen's Source concept, where the electric sheet admittance and the magnetic sheet impedance are equal and purely imaginary, so that the amplitude of the unit cell's magnitude is equal to 1. The phase of each unit cell can be varied by adjusting the magnitude of each unit cell. Notably, this concept does not require a focal length, and hence metamaterial RF lenses may be placed closer to a radiating element than typical optical lenses.

As shown in FIG. 2B, a separate metamaterial RF lens 150 is provided for each of the low-band radiating elements 122 in the first and second low-band arrays 120-1, 120-2, and hence a total of twelve metamaterial RF lens 150 are provided. The metamaterial RF lens 150 are implemented using printed circuit boards in the depicted embodiment. While each metamaterial RF lens 150 is implemented in a separate printed circuit board in the depicted embodiment, it will be appreciated that in other embodiments multiple metamaterial RF lens 150 may be implemented in a single printed circuit board. For example, the six metamaterial RF lens 150 in the first array 140-1 could be implemented in a first printed circuit board and the six metamaterial RF lens 150 in the second array 140-2 could be implemented in a second printed circuit board in other embodiments, so that only two printed circuit boards are required. Each metamaterial RF lens 150 may be mounted directly in front of a corresponding one of the low-band radiating elements 122.

Each metamaterial RF lens 150 may have a footprint that is larger than a footprint of the low-band radiating element 122 that the lens 150 is mounted in front of. Herein, a footprint of a structure such as a metamaterial RF lens or a radiating element refers to the area of a smallest rectangle that encloses the structure when the structure is viewed from the front. Generally speaking, the larger the metamaterial RF lens 150, the greater the amount of focusing of the low-band RF energy that is provided. There is a tradeoff, however, between the degree of focusing and weight and cost, as larger printed circuit boards increase both the weight and the cost of base station antenna 100.

FIG. 2D is a front view of one of the metamaterial RF lens 150 shown in FIG. 2B. FIGS. 2E-2G are enlarged views of the three different unit cells included in the metamaterial RF lens 150 of FIG. 2D. As shown, the metamaterial RF lens 150 is implemented in a printed circuit board 152 that includes a dielectric substrate 154 having first and second metallization patterns 156-1, 156-2 formed on the major surfaces of the dielectric substrate 154. While only the first metallization pattern 156-1 is visible in FIG. 2D, it will be appreciated that the second metallization patterns 156-1 may be identical to the metallization patterns 156-1 and the first and second metallization patterns 156-1, 156-2 may exactly overlap in a direction perpendicular to the major surfaces of the dielectric substrate 154. The dielectric substrate 154 may be thin. For example, a thickness of the dielectric substrate may be less than 30 mm or less than 20 mm in example embodiments.

The metamaterial RF lens 150 has a unit cell structure, and includes five rows 160-1 through 160-5 and five columns 162-1 through 162-5 of unit cells for a total of twenty-five unit cells. The metamaterial RF lens 150 has an aperiodic structure, meaning that some unit cells have a different design than other of the unit cells. As can be seen from FIG. 2D, metamaterial RF lens 150 has three different unit cell designs, namely first unit cells 170, second unit cells 180 and third unit cells 190.

Referring to FIGS. 2D-2E, the metamaterial RF lens 150 includes a single first unit cell 170, which is positioned in the center of the metamaterial RF lens 150. The first unit cell 170 comprises four arcuate conductive traces 172-1 through 172-4 that together define a circular ring 174 that has four small gaps 176 therein. A meandered conductive trace 178 extends inwardly into the circular ring 174 from each end of the four arcuate conductive traces 172-1 through 172-4 so that a total of eight meandered conductive trace 178 extend inwardly into the circular ring 174. The meandered conductive traces 178-1 through 178-8 are arranged in pairs that extend in “parallel” to each other, meaning that the segments of the first meandered conductive trace 178 of the pair extend in parallel to respective segments of the second meandered conductive trace 178 of the pair. The distance between the parallel segments of each meandered conductive trace 178 of the pair may be constant in some embodiments. The pairs of meandered conductive traces 178 extend from the circular ring 174 at positions that are radially separated from each other by about 90°. Each meandered conductive trace 178 extends approximately halfway towards the center of the circular ring 174.

The metamaterial RF lens 150 includes eight second unit cells 180. The eight second unit cells 180 form a square that surrounds the first unit cell 170. Each second unit cell 180 comprises four arcuate conductive traces 182-1 through 182-4 that together define a circular ring 182 that has four small gaps 184 therein.

The metamaterial RF lens 150 includes sixteen third unit cells 190. The sixteen third unit cells 190 form a square that surrounds the second unit cells 180. Each third unit cell 190 comprises four arcuate conductive traces 192-1 through 192-4 that together define a circular ring 194 that has four small gaps 196 therein. A meandered conductive trace 198 extends inwardly into the circular ring 194 from each end of the four arcuate conductive traces 192-1 through 192-4 so that a total of eight meandered conductive trace 198 extend inwardly into the circular ring 194. The meandered conductive traces 198-1 through 198-8 are arranged in pairs that extend in “parallel” to each. The distance between the parallel segments of each meandered conductive trace 198 of the pair may be constant in some embodiments. The pairs of meandered conductive traces 198 extend from the circular ring 194 at positions that are radially separated from each other by about 90°. Each meandered conductive trace 198 extends over 75% of the distance from the edge of the circular ring 194 into the center of the circular ring 194.

As shown in FIG. 2D, the third unit cells 190 extend around the periphery of the metamaterial RF lens 150 (i.e., each third unit cell 190 is an outer unit cell that is at an edge of the metamaterial RF lens 150), while the first unit cells 170 and the second unit cells 180 are within the periphery (i.e., all of the first and second unit cells 170, 180 are inner unit cells that are not at an edge of the metamaterial RF lens 150).

While FIG. 2D illustrates a metamaterial RF lens 150 that is implemented using printed circuit board technology, it will be appreciated that embodiments of the present invention are not limited thereto. For example, in other embodiments the metamaterial RF lens 150 may be implemented using various metallization on plastic techniques such as laser direct sintering, three-dimensional printing techniques and the like, or could be implemented using punched sheet metal that is mounted on a dielectric substrate or simply suspended in front of an associated low-band radiation element 122.

Referring to FIGS. 2B and 2C, it can be seen that the mid-band radiating elements 132 are mounted rearwardly of the metamaterial RF lens 150, and hence most of the RF radiation emitted (and received) by the mid-band linear arrays 130 will travel through the metamaterial RF lens 150. Since the mid-band radiating elements 132 are much smaller than the low-band radiating elements, they do not pose the same size and isolation problems as the low-band radiating elements 122, and hence the mid-band radiating elements 132 typically have radiation patterns that are already optimized for providing good coverage to a 120° sector while having acceptable levels of spill-over RF radiation into neighboring sectors. Thus, in most situations, it may be preferred that the metamaterial RF lens 150 not impact the antenna beams generated by the mid-band linear arrays 130.

As discussed above, each of the unit cells include 170, 180, 190 comprises a plurality of metal traces. As shown in FIGS. 2E-2G, the arcuate metal traces 172, 182, 192 and the meandered conductive traces 178, 198 are narrow traces that will exhibit high inductance values. These traces may be configured so that they have a high pass filter effect, meaning that the unit cells 170, 180, 190 may be mostly or completely transparent to RF radiation in the mid-band operating frequency range while acting to focus RF radiation in the low-band operating frequency range. In other words, the metamaterial RF lens 150 may be substantially cloaked with respect to mid-band RF radiation so that the metamaterial RF lens 150 have only minimal impact on the mid-band RF radiation while acting as a lens with respect to low-band RF radiation. It will be appreciated that the degree of cloaking may tend to be smaller for portions of the mid-range operating frequency band that are relatively close to the low-band operating frequency range, and larger for portions of the mid-range operating frequency band that are farther from the low-band operating frequency range. Typically, the best cloaking performance will be achieved at the highest frequency of the mid-band operating frequency range. Thus, each array 140 of metamaterial RF lenses 150 may be configured to reduce a half power azimuth beamwidth of an antenna beam generated by an associated array 120 of low-band radiating elements 122, and may be configured to be substantially transparent to RF radiation at a highest frequency in the mid-band frequency range.

Metamaterial RF lens are known. Existing metamaterial RF lenses, however, tend to be relatively thick, and hence increase the depth of the antennas in which they are used. More importantly, while known metamaterial RF lenses are effective in increasing the directivity of an associated radiating element, they tend to have a narrowband response that is unsuitable for cellular base station applications, where the bandwidths of the operating frequency bands are typically on the order of 20-35% (where the bandwidth is defined as the uppermost frequency in the operating frequency band minus the lowermost frequency in the operating frequency band, and this difference is divided by the uppermost frequency in the operating frequency band), because the metamaterial RF lenses have impedance matching issues with the dipole arms of the radiating elements. As such, the improvement in directivity provided by known metamaterial RF lenses is often offset by the increase in return loss, such that the gain of the radiating element or array of radiating elements is not improved. While the problem of increased return loss may be partially mitigated by spacing the metamaterial RF lenses farther from their associated radiating elements, this may require an increase in the footprint of each metamaterial RF lens to provide an equivalent amount of focusing, and exacerbates the degree to which the depth of the antenna must be increased to accommodate the metamaterial RF lenses.

Existing metamaterial RF lenses typically have a periodic unit cell structure, meaning that each such lens only has a single unit cell design, and the unit cell design is repeated throughout the entirety of the lens structure. In practice, this contributes to the above-discussed impedance matching problem, as the unit cells in the middle of these known metamaterial RF lenses receive the highest amounts of RF radiation from the radiating element and are also the closest unit cells to the radiating element. Embodiments of the present invention are based, in part, on the realization that by using aperiodic unit cell designs, various of the advantages provided by metamaterial RF lenses may be harnessed while avoiding or at least reducing the negative qualities of known metamaterial RF lenses.

In particular, one attribute of metamaterial RF lenses is that they focus the RF radiation passing therethrough by adjusting the phase of the RF radiation. When designing a linear array of radiating elements for a base station antenna that provides coverage to a 120° sector in the azimuth plane, the goal of the antenna designer is not to heavily focus the RF energy emitted by the linear array, but instead is to relatively evenly distribute the RF radiation throughout the sector while reducing or minimizing the amount of RF radiation that falls outside of the sector. Thus, in sector base station antenna applications, the best performance may be provided by redirecting the RF radiation that would fall outside of the sector to instead fall within the sector. Generally speaking, the RF radiation that will fall outside the sector is the RF radiation that is emitted at larger azimuth and elevation angles by the radiating elements in the linear array. Assuming that a metamaterial RF lens is placed directly in front of each radiating element in the linear array and has a footprint that is larger than the radiating element, then the RF radiation that is emitted at these higher azimuth and elevation angles will tend to impinge on the unit cells of the metamaterial RF lenses that extend around the periphery of the metamaterial RF lenses. Thus, performance may be improved by adjusting the phases of the RF radiation received in these unit cells. Since the direction of the RF radiation that is emitted at higher azimuth and elevation angles typically must be adjusted the most, the unit cells around the periphery of each metamaterial RF lens may be designed to impart relatively large phase adjustments. Generally speaking, to achieve larger phase adjustments, the unit cells need to have larger amounts of metal, which exacerbates the above-discussed impedance matching problems. However, the unit cells that extend around the periphery of a metamaterial RF lens that has a footprint that is larger than the footprint of its associated radiating element will tend to have less of an impact on the impedance match because (1) these unit cells are located farther from the dipole radiators and (2) these unit cells receive a smaller percentage of the RF radiation emitted by the associated radiating element. Thus, by designing the metamaterial RF lenses so that the unit cells that extend around the periphery of the metamaterial RF lens are configured to impart greater amounts of phase change (at least on average) than the remaining unit cells of the metamaterial RF lens, the metamaterial RF lenses may be designed to significantly improve the shape of the antenna beam and hence the performance of the associated linear array while still providing good impedance matching.

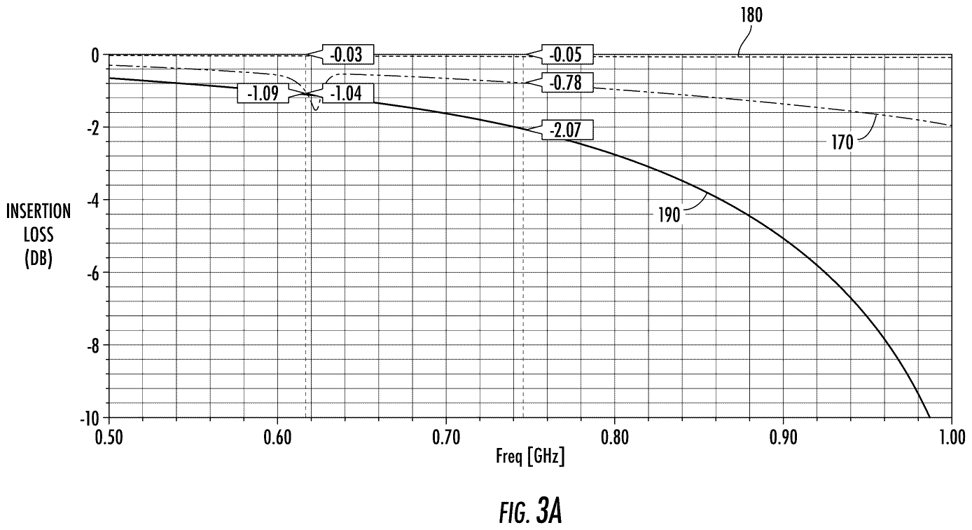

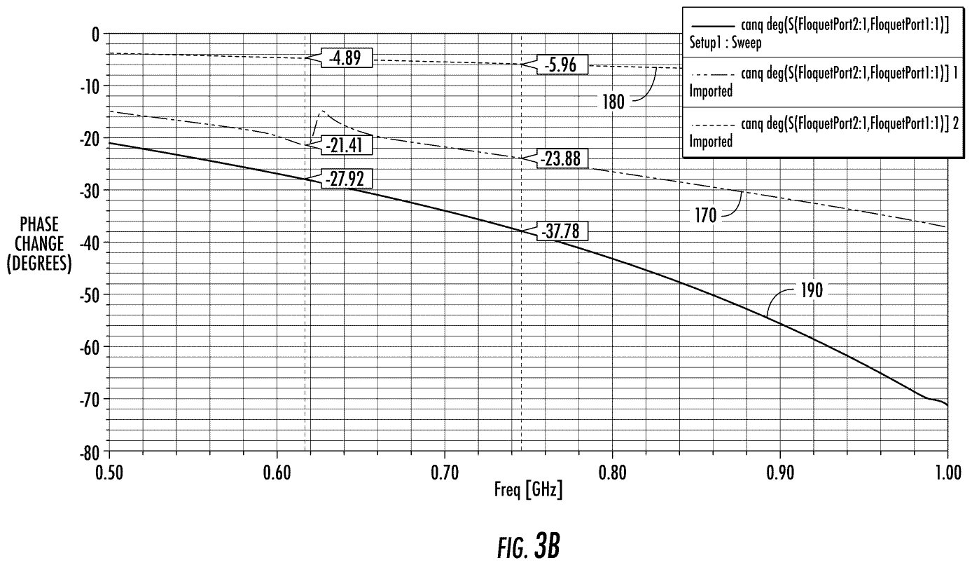

Referring again to FIG. 2D, it can be seen the metamaterial RF lens 150 is designed in the manner discussed above. In particular, the third unit cells 190 that extend around the periphery of the metamaterial RF lens 150 are designed to impart large amounts of phase adjustment, while the first and second unit cells 170, 180 are designed to impart only small amounts of phase adjustment. The graphs of FIGS. 3A and 3B illustrate how this design may be used to advantageously shape the antenna beam while only having a relatively minor impact on the insertion loss of the linear arrays 120.

In particular, FIG. 3A is a graph that shows the simulated insertion loss as a function of frequency of the metamaterial RF lens 150 of FIG. 2D when mounted 10 mm in front of one of the low-band radiating elements 122 of the base station antenna 100 of FIGS. 2A-2C. The three curves in the graph of FIG. 3A show the insertion loss for the respective first, second and third unit cells 170, 180, 190. As shown in FIG. 3A, the second unit cells 180 have almost no insertion loss over the entire 617-696 MHz low-band operating frequency band, while the first unit cell 170 has relatively low insertion loss (e.g., between −0.4 to −0.6 dB) in the lower portion of the low-band operating frequency band, but increasing insertion loss (up to about −1.6 dB) in the upper portion of the low-band operating frequency band. In stark contrast, the third unit cells 190 have much higher insertion loss, staring at over −1 dB in the lower portion of the low-band operating frequency band and peaking at about −8 dB at the upper end of the low-band operating frequency band. As shown in FIG. 3A, at 746 MHz, the first, second and third unit cells 170, 180, 190 exhibit insertion loss values of −0.78 dB, −0.05 dB and −2.07 dB.

The insertion loss associated with the second unit cells 180 is essentially negligible and does not have any appreciable impact on the performance of the low-band linear array 120 associated with the array of metamaterial RF lenses 140. While the insertion loss associated with the first unit cell 170 is higher, only a single first unit cell 170 is provided in each metamaterial RF lens 150 and hence the contribution of the single first unit cell 170 to the insertion loss for each metamaterial RF lens 150 is again quite low. The insertion loss values associated with the third unit cells 190 are much greater, and such insertion loss values would be too high for a commercially practical base station antenna. However, as discussed above, the third unit cells 190 are spaced farther away from the dipole radiators of their associated low-band radiating elements 122 than the first and second unit cells 170, 180, and hence in practice the insertion loss values will be lower for the third unit cells 190 than what is shown in FIG. 3A, as the impact of the unit cells on the insertion loss increases the farther the unit cells are spaced apart from the dipole radiators of the low-band radiating elements 122. Moreover, while sixteen of the twenty-five unit cells (i.e., 64%) in each metamaterial RF lens 150 are third unit cells 190, the RF radiation emitted by the associated low-band radiating element 122 that will pass through the third unit cells 190 is much less than 64%, since the third unit cells are spaced around the periphery of the metamaterial RF lens 150. As such, while the third unit cells 190 will tend to increase the insertion loss of the linear array 120 to a degree, the overall impact of the metamaterial RF lens 150 on the insertion loss may be small (e.g., less than −2.0 dB).

FIG. 3B is a graph that illustrate the amount of phase adjustment imparted by the respective first through third unit cells 170, 180, 190 as a function of frequency. As shown, the amount of phase adjustment imparted by each unit cell 170, 180, 190 increases with increasing frequency, with the third unit cells 190 imparting the greatest amount of phase adjustment. As discussed above, this larger amount of phase adjustment may be used to redirect at least some of RF radiation emitted by the low-band radiating elements 122 that is directed outside a sector to be within the sector, improving the azimuth and elevation beamwidths of the antenna beam generated by the linear array 120, as well as improving the gain and sector power ratio thereof. Thus, the metamaterial RF lenses according to embodiments of the present invention may focus the RF radiation emitted by a linear array in a favorable manner, improving the performance thereof.

Referring again to FIGS. 2A-2G, a base station antenna 100 is provided that comprises a first RF port 126-1, a first array 120-1 of low-band radiating elements 122, where each of the low-band radiating elements 122 in the first array 120-1 is coupled to the first RF port 126-1, and a first plurality 140-1 of metamaterial RF lenses 150 that are mounted forwardly of the first array 120-1, where each metamaterial RF lens 150 comprises a plurality of unit cells 170, 180, 190, and at least two of the unit cells 170, 180, 190 have different metallization patterns. For example, each metamaterial RF lens 150 includes first unit cells 170 that each have a first metallization pattern, second unit cells 180 that each have a second metallization pattern that is different than the first metallization pattern, and third unit cells 190 that each have a third metallization pattern that is different than both the first metallization pattern and the second metallization pattern. The third unit cells 190 that extend around a periphery of a first of the metamaterial RF lenses 150 are configured to impart a larger average phase change to first frequency band RF radiation incident thereto than are the first and second unit cells 170, 180 that are within the periphery of the first of the metamaterial RF lenses 150.

The base station antenna 100 further comprises a reflector 110, and the dipole radiators 124-1, 124-2 of the respective low-band radiating elements 122 in the first array 120-1 are positioned forwardly of the reflector 110. Moreover, base station antenna 100 further comprises a second RF port 126-3 and a second array 120-2 of low-band radiating elements 122, where each of the low-band radiating elements 122 in the second array 120-1 is coupled to the second RF port 126-3. The first array 120-1 and the second array 120-2 have respective longitudinal axes that each extend in the longitudinal direction L, and are spaced apart from each other in a transverse direction T that is perpendicular to the longitudinal direction and to a forward direction F. The base station antenna 100 further comprises a second plurality 140-2 of metamaterial RF lenses 150 that are mounted forwardly of the second array 120-2.

The metamaterial RF lenses 150 are planar structures and may be implemented, for example, in one or more printed circuit boards. In the embodiment shown in FIG. 2B, each metamaterial RF lens 150 is formed in a respective printed circuit board. While not shown in the figures, in other embodiments, all of the metamaterial RF lens 150 that are mounted forwardly of the first array 120-1 may be implemented in a single printed circuit board.

As can best be seen in the enlarged views of FIGS. 2E-2G, all twenty five unit cells 170, 180, 190 included in each of the metamaterial RF lenses 150 comprises four arcuate metal traces 172, 182, 192 that define respective circular rings 174, 184, 194 that have respective gaps 176, 186, 196 therein. At least some of the unit cells 170, 180, 190 (here the first and third unit cells 170, 190) comprise a plurality of meandered metal traces 178, 198. The meandered metal traces 178, 198 of each unit cell 170, 190 that includes meandered traces 178, 198 extend inwardly from the circular rings 174, 194 of the unit cells.

As discussed above, a problem that arises in base station antennas that include two low-band linear arrays is that in order to meet customer expectations regarding the width of the antenna, it is typically necessary to have only a small gap between the two low-band linear arrays. Because the radiating elements of the two low-band linear arrays are in close proximity, RF radiation emitted by the first low-band linear array tends to couple to the second low-band linear array and vice versa, which acts to distort the antenna beams generated by both linear arrays.

As discussed above, the metamaterial RF lenses according to embodiments of the present invention may redirect RF radiation that is at higher azimuth and elevation angles back toward lower azimuth and elevation angles. This redirection may advantageously improve the isolation between two linear arrays that are positioned in closed proximity to each other. Moreover, according to some embodiments of the present invention, asymmetric aperiodic metamaterial RF lenses may be provided that are designed to enhance the isolation between two adjacent linear arrays.

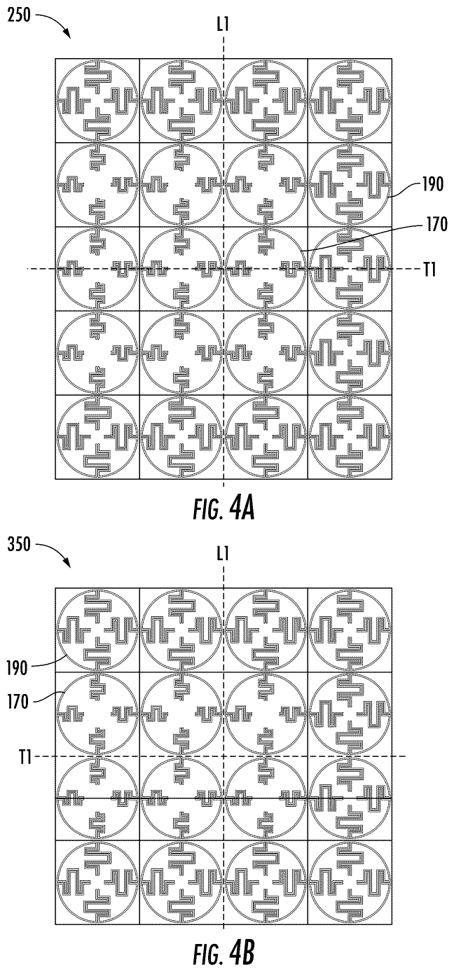

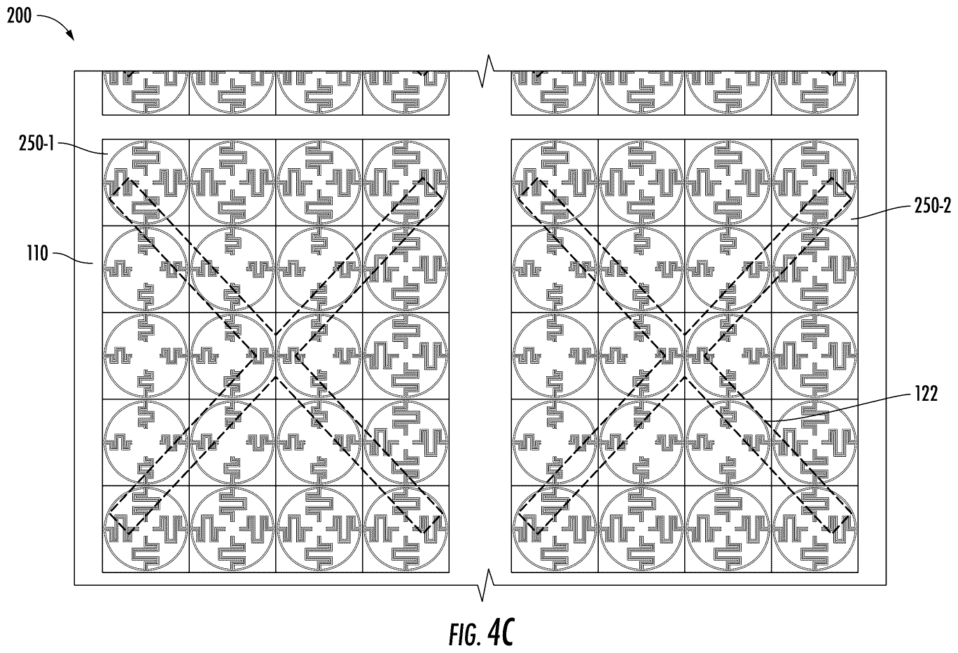

FIG. 4A is a front view of an asymmetric aperiodic metamaterial RF lens 250 according to further embodiments of the present invention. The aperiodic metamaterial lenses 150 that are included in the base station antenna 100 of FIGS. 2A-2C may be replaced with the asymmetric aperiodic metamaterial RF lens 250 to provide a base station antenna according to further embodiments of the present invention.

As shown in FIG. 4A, the metamaterial RF lens 250 may have various similarities to the metamaterial RF lens 150 of FIG. 2D. However, metamaterial RF lens 250 differs from metamaterial RF lens 150 in that it comprises a five row by four column array of unit cells so that each metamaterial RF lens 250 will have a total of twenty unit cells. In addition, the metamaterial RF lens 250 only includes first unit cells 170 and third unit cells 190. The third unit cells 190 extend along the right side, the top side and the bottom side of the metamaterial RF lens 250 if the metamaterial RF lens 250 is mounted in front of the low-band linear array 120 that is on the left side of the base station antenna. The third unit cells 190 and the three leftmost of the first unit cells 170 extend around the periphery of the metamaterial RF lens 250. The remaining six of the first unit cells 170 are within the interior of metamaterial RF lens 250.

The five third unit cells that extend along the right side of metamaterial RF lens 250 may act as a decoupling structure that reduces coupling between the first and second low-band linear arrays 120-1, 120-2. In particular, by redirecting RF radiation to lower azimuth and elevation angles, less of the RF radiation emitted by the radiating elements 122 of the first low-band linear array 120-1 will couple to the radiating elements 122 of the second low-band linear array 120-2, and vice versa. Each metamaterial RF lens 250 in the first array 140-1 of metamaterial RF lenses 250 (which is the array on the left) would have the design shown in FIG. 4A. Each metamaterial RF lens 250 in the second array 140-1 of metamaterial RF lenses 250 (which is the array on the right) would also have the design shown in FIG. 4A, but each metamaterial RF lens 250 would be rotated 180° so that the third unit cells 190 extend along the top, bottom and left sides of the metamaterial RF lens 250.

FIG. 4B is a front view of an asymmetric aperiodic metamaterial RF lens 350 according to further embodiments of the present invention. The aperiodic metamaterial lenses 150 that are included in the base station antenna 100 of FIGS. 2A-2C may be replaced with the asymmetric aperiodic metamaterial RF lens 350 to provide a base station antenna according to still further embodiments of the present invention.

As shown in FIG. 4B, the metamaterial RF lens 350 may have various similarities to the metamaterial RF lens 150 of FIG. 2D. However, metamaterial RF lens 350 differs from metamaterial RF lens 150 in that it comprises a four row by four column array of unit cells so that each metamaterial RF lens 350 will have a total of sixteen unit cells. In addition, the metamaterial RF lens 350 only includes first unit cells 170 and third unit cells 190. The third unit cells 190 extend along the right side, the top side and the bottom side of the metamaterial RF lens 350 if the metamaterial RF lens 350 is mounted in front of the low-band linear array 120 that is on the left side of the base station antenna. The third unit cells 190 and the two leftmost of the first unit cells 170 extend around the periphery of the metamaterial RF lens 350. The remaining four of the first unit cells 170 are within the interior of metamaterial RF lens 350.

The four third unit cells that extend along the right side of metamaterial RF lens 350 may act as a decoupling structure that reduces coupling between the first and second low-band linear arrays 120-1, 120-2. In particular, by redirecting RF radiation to lower azimuth and elevation angles, less of the RF radiation emitted by the radiating elements 122 of the first low-band linear array 120-1 will couple to the radiating elements 122 of the second low-band linear array 120-2, and vice versa. Each metamaterial RF lens 350 in the first array 140-1 of metamaterial RF lenses 350 (which is the array on the left) would have the design shown in FIG. 4B. Each metamaterial RF lens 350 in the second array 140-1 of metamaterial RF lenses 350 (which is the array on the right) would also have the design shown in FIG. 4B, but each metamaterial RF lens 350 would be rotated 180° so that the third unit cells 190 extend along the top, bottom and left sides of the metamaterial RF lens 350.

As best shown in FIGS. 4A and 4B, the unit cells 170, 190 of each metamaterial RF lenses 250, 350 are arranged asymmetrically. In some embodiments, the unit cells may be arranged asymmetrically about a first longitudinal axis L1 and/or may be arranged asymmetrically about a first transverse axis T1. In the embodiments shown in FIGS. 4A and 4B, the unit cells 170, 190 are arranged asymmetrically about a first longitudinal axis L1.

FIG. 4C is a schematic front view of a small portion of a base station antenna 200 that is identical to base station antenna 100 except that each metamaterial RF lens 150 of base station antenna 100 is replaced in base station antenna 200 with a metamaterial RF lens 250. FIG. 4C illustrates the orientations of the metamaterial RF lens 250 in base station antenna 200, as the depicted orientation provides improved isolation between the first and second low-band arrays 120-1, 120-2 included in base station antenna 200.

As shown in FIG. 4C, a first metamaterial RF lens 250-1 that is mounted in front of and overlapping a radiating element 122 of the first low-band array 120-1 (which is on the left when base station antenna 200 is viewed from the front) is oriented so that the column of unit cells that includes all third unit cells 190 is the column of unit cells that is closest to the second low-band array 120-2. As is further shown in FIG. 4C, a second metamaterial RF lens 250-2 that is mounted in front of and overlapping a radiating element 122 of the second low-band array 120-2 (which is on the right when base station antenna 200 is viewed from the front) is oriented so that the column of unit cells that includes all third unit cells 190 is the column of unit cells that is closest to the first low-band array 120-2. Thus, it can be seen from FIG. 4C that the metamaterial RF lenses 250 that are mounted in front of second low-band array 120-2 are rotated 180° in the plane defined by the longitudinal and transvers directions L, T with respect to the metamaterial RF lenses 250 that are mounted in front of first low-band array 120-1.

As discussed above, the third unit cells 190 are configured to impart a larger phase change to first frequency band RF radiation incident thereto than are the first unit cells 170. Thus, since the rightmost column of unit cells of the first metamaterial RF lens 250-1 only includes third unit cells 190, the unit cells in this column will impart, on average, a larger phase change to first frequency band RF radiation incident thereto than will the remaining unit cells of the first metamaterial RF lens 250-1. The amount of phase change that a unit cell will impart on RF radiation emitted in a specific frequency band (e.g., the low-band operating frequency range) is determined as the amount of phase change imparted to RF radiation at the center frequency of the specific frequency band. As shown in FIG. 3B, the third unit cells 190 impart a phase change of about 50° at the 788.5 MHz center frequency of the 617-960 MHz low-band operating frequency range. Since the rightmost column of unit cells of the first metamaterial RF lens 250-1 only includes third unit cells 190, the average phase change that the unit cells in the rightmost column of unit cells of the first metamaterial RF lens 250-1 will impart on low-band RF radiation is about 50°. The remaining unit cells 170, 190 in the first metamaterial RF lens 250-1 comprise six third unit cells 190 and nine first unit cells 170. As shown in FIG. 3B, the first unit cells 170 impart a phase change of about 30° at the 788.5 MHz center frequency of the 617-960 MHz low-band operating frequency range. Thus, the average phase change that the remaining unit cells in of the first metamaterial RF lens 250-1 will impart on low-band RF radiation is [(6*50°)+(9*30°)]/15=38°. As discussed above, such a design acts to increase isolation between the first low-band array 120-1 and the second low-band array 120-2.

It is also readily apparent from FIG. 4C that the unit cells 190 in the first column of unit cells of the first metamaterial RF lens 250-1 that is closest to the second array 120-2 of low-band radiating elements 122 include, on average, more metal than do the remaining unit cells 170, 190 of the first metamaterial RF lens 250-1. Additionally, the meandered traces 178, 198 included in the unit cells 190 in the first column of unit cells of the first metamaterial RF lens 250-1 that is closest to the second array 120-2 of low-band radiating elements 122 are, on average, longer than the meandered traces 178, 198 included in the remaining unit cells 170, 190 of the first metamaterial RF lens 250-1, since the first unit cells 170 have shorter meandered conductive traces than do the third unit cells 190.

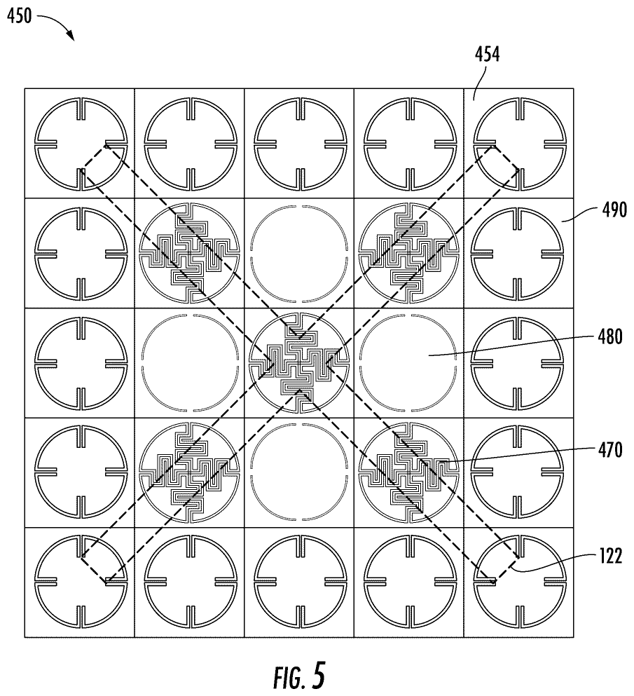

FIG. 5 is a schematic front view of an aperiodic metamaterial RF lens 450 according to additional embodiments of the present invention. The aperiodic metamaterial lenses 150 that are included in the base station antenna 100 of FIGS. 2A-2C may be replaced with the aperiodic metamaterial RF lens 450 to provide a base station antenna according to yet additional embodiments of the present invention. The location of the low-band radiating element 122 that is associated with the metamaterial RF lens 450 is shown in FIG. 5 using dashed lines.

As shown in FIG. 5, the aperiodic metamaterial RF lens 450 includes three different types of unit cells, namely first unit cells 470, second unit cells 480 and third unit cells 490. The metamaterial RF lens 450 may be implemented in a printed circuit board 452 that includes a dielectric substrate 454 having metallization patterns 456 formed on the two major surfaces thereof. The metamaterial RF lens 450 includes five rows 460 and five columns 462 of unit cells for a total of twenty-five unit cells.

The metamaterial RF lens 450 includes five first unit cells 470, four second unit cells 480, and sixteen third unit cells 490. The five first unit cells 470 are arranged to form an “X” shape within the central portion of the metamaterial RF lens 450 when the metamaterial RF lens 450 is viewed from the front. The sixteen third unit cells 490 form an annular square that forms the periphery of metamaterial RF lens 450. These third unit cells 490 are in the same positions as the third unit cells 190 of metamaterial RF lens 150. The four second unit cells 480 are within the central region of metamaterial RF lens 450 and, in combination with the central one of the first unit cells 470, form a cross-shape within the central portion of the metamaterial RF lens 450 when the metamaterial RF lens 450 is viewed from the front.

In this embodiment, each first unit cell 470 is nearly identical to the third unit cells 190 that are discussed above, with the only difference being that the meandered conductive traces 478 included in the first unit cells 470 are even longer than the meandered conductive traces 198 included in the third unit cells 190. The second unit cells 480 may be identical to the second unit cells 180 discussed above, so further description thereof will be omitted. The third unit cells 490 include four arcuate metal traces 492 that define a circular ring 494. A short metal trace 498 extends inwardly from each end of each arcuate metal trace 492.

The metamaterial RF lens 450 is designed to work with slant −/+45° cross-dipole radiating elements, such as the low-band radiating elements 122 included in base station antenna 100. As shown in FIG. 5, when the metamaterial RF lens 450 is positioned directly in front of one of the low-band radiating elements 122, with the center of the metamaterial RF lens 450 and the center of the low-band radiating element 122 aligned along an axis that extends in the forward direction F, the first unit cells 470 are positioned directly in front of the cross-dipole radiators 124-1, 124-2. Notably, the first unit cells 470 are the unit cells that are configured to impart the greatest amount of phase adjustment. In light of their positioning, the first unit cells 470 may receive a significant amount of the RF radiation emitted by the low-band radiating element mounted behind the metamaterial RF lens 450, and hence may have an outsized focusing effect.

Thus, referring to FIGS. 2A-2C and 5, pursuant to further embodiments of the present invention, a base station antenna is provided that comprises a reflector 110 and first and second RF ports 126-1, 126-3, and first and second arrays 120-1, 120-2 of low-band radiating elements 122 that each extend in a longitudinal direction L and are spaced apart from each other in a transverse direction T that is perpendicular to the longitudinal direction L. Each of the low-band radiating elements 122 in the first array 120-1 is coupled to the first RF port 126-1 and each of the low-band radiating elements 122 in the second array 120-2 is coupled to the second RF port 126-2. The base station antenna further comprises a metamaterial RF lens 450 that comprises a plurality of unit cells mounted forwardly of a first of the low-band radiating elements 122 in the first array 120-1, the metamaterial RF lens 450 overlapping the first of the low-band radiating elements 122 in a forward direction F that is perpendicular to both the longitudinal direction L and the transverse direction T. A first subset of the unit cells of the metamaterial RF lens 450 that overlap dipole radiators 124-1, 124-2 of the first of the low-band radiating elements 122 in the forward direction F include a greater amount of metal, on average, than are the remaining unit cells of the metamaterial RF lens 450. In addition, a first subset of the unit cells of the metamaterial RF lens 450 that overlap the radiators 124-1, 124-2 of a first of the low-band radiating elements 122 in the forward direction F are configured to impart a larger average phase change to first frequency band RF radiation incident thereto than are the remaining unit cells of the metamaterial RF lens 450.

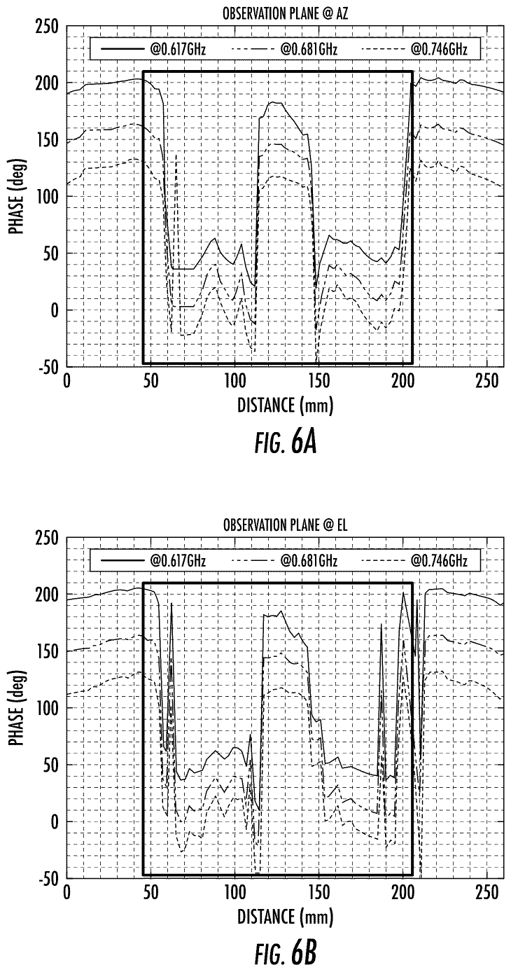

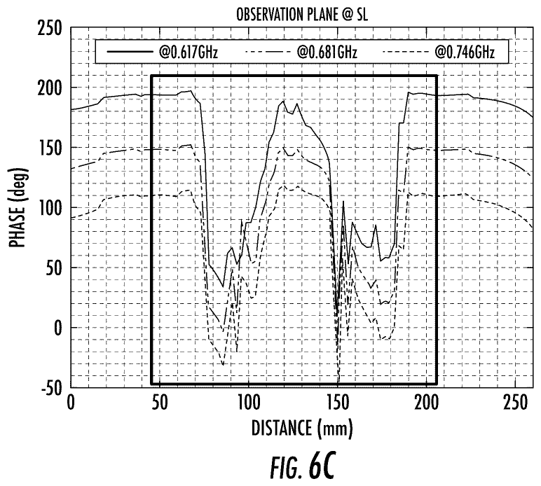

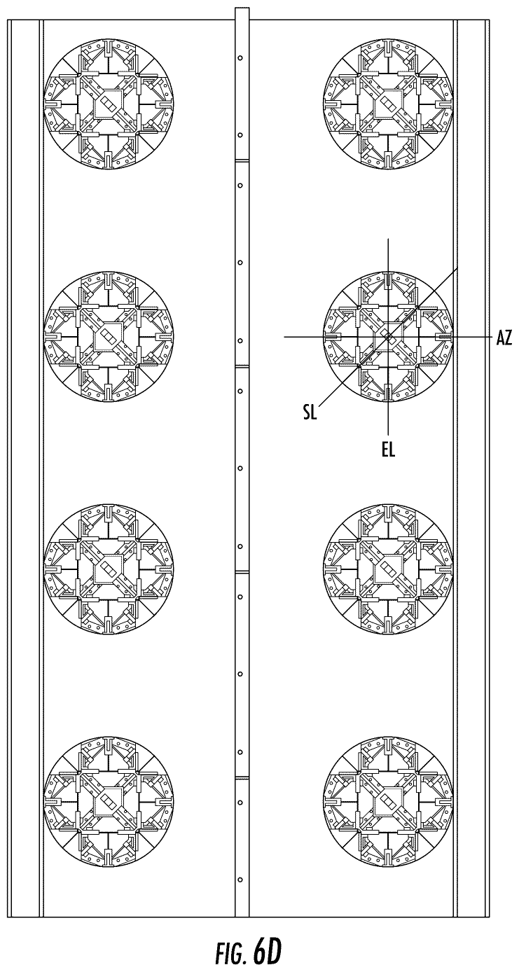

Referring again to the base station antenna 100 of FIGS. 2A-2G, generally speaking, the performance of the low-band arrays 120 will be better the flatter the phase response of the RF radiation emitted by the low-band radiating elements 122 after the RF radiation has passed through the metamaterial RF lenses 150. FIGS. 6A-6C are graphs that illustrate the simulated phase response for a single low-band radiating element of a base station antenna having the design of base station antenna 100 of FIGS. 2A-2G, except that the graphs of FIGS. 6A-6C were generated under the assumption that the metamaterial RF lenses 150 were omitted from base station antenna 100. The phase responses shown in FIGS. 6A-6C illustrate the phase of the RF energy as a function of distance from the center of the low-band radiating element 122 as observed along three cut lines corresponding to (1) a plane bisecting the low-band radiating element 122 along the azimuth plane (FIG. 6A), (2) a plane bisecting the low-band radiating element 122 along the elevation plane (FIG. 6B), and a plane bisecting the low-band radiating element 122 along a plane that is midway between the azimuth and elevation planes (FIG. 6C). FIG. 6D is a schematic front view of the base station antenna that illustrates the planes of the three cut lines corresponding to the phase responses shown in FIGS. 6A-6C, where “AZ” is the cutline for FIG. 6A, “EL” is the cutline for FIG. 6B, and “SL” is the cutline for FIG. 6C. Each of the graphs of FIGS. 6A-6C include three curves, which show the phase response at three different frequencies within the low-band operating frequency range, namely 617 MHz, 681 MHz and 746 MHz. In FIGS. 6A-6C, the large rectangles that are superimposed on the respective graphs show the footprint of the low-band radiating element 122.

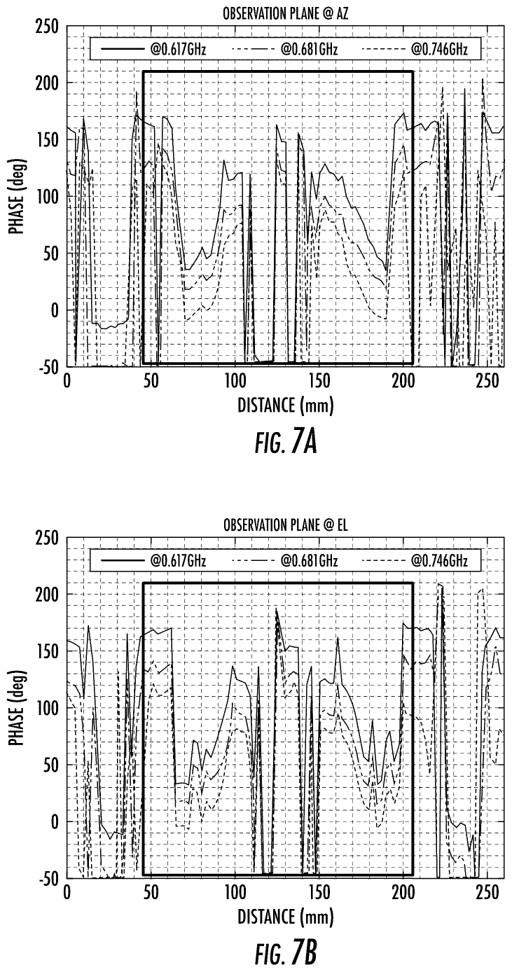

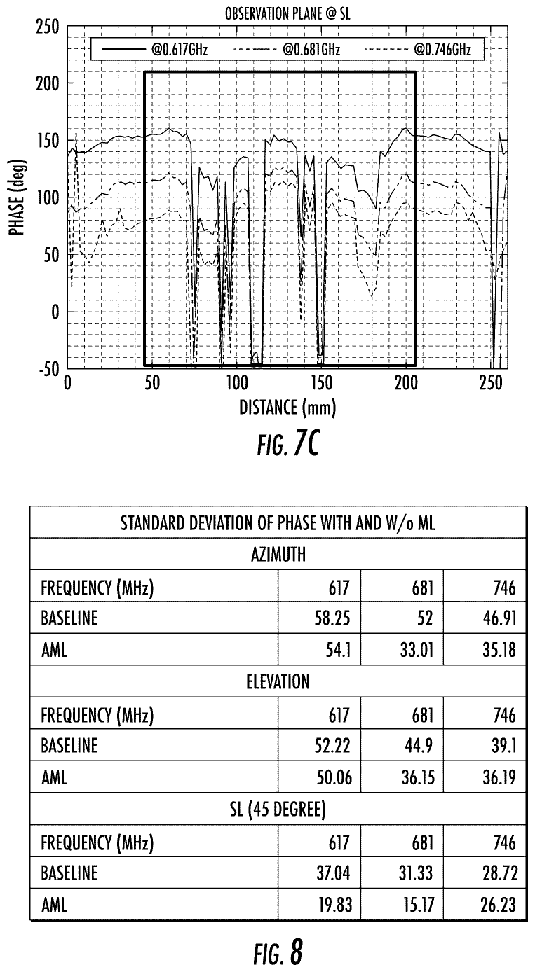

FIGS. 7A-7C are graphs that illustrate the simulated phase response for a single low-band radiating element of a base station antenna having the design of base station antenna 100 of FIGS. 2A-2G, where the metamaterial RF lenses 150 are present in the antenna. The graphs of FIGS. 7A-7C correspond to the graphs of FIGS. 6A-6C, respectively, with the only difference being that in the simulation used to generate the graphs of FIGS. 7A-7C the metamaterial RF lenses 150 were included in the antenna 100.

FIG. 8 is a table that compares the standard deviation of the phase responses shown in FIGS. 6A-6C (baseline) to the corresponding phase responses shown in FIGS. 7A-7C (AML). As shown in the table of FIG. 8, the phase responses of the base station antenna having the metamaterial RF lenses 150 is flatter (i.e., a lower standard deviation) at all three frequencies along all three cut lines. It should be noted from the table of FIG. 8 that adding the metamaterial RF lenses provides the greatest improvement in the phase response along the “SL” cut line, which is along the direction of the dipole radiators of the low-band radiating elements 122 (since the low-band radiating elements 122 use +/−45° cross-dipole radiators). Flattening the phase response along this cutline may be particularly important for improving the shape of the antenna beams generated by the low-band arrays 120.

It will be appreciated that many modifications may be made to the above example embodiments without departing from the scope of the present invention. For example, the number or arrangement of unit cells may be varied from what is shown herein. Additionally, the metamaterial RF lenses may be used with arrays other than low-band linear arrays, such as with mid-band linear arrays or with mid-band or high-band multi-column beamforming arrays. Likewise the number of columns of metal rings in both the forward and transverse directions may be varied from what is shown above.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Herein, a first element overlaps a second element in a given direction (e.g., the forward direction) if an axis that extends in the direction passes through both elements.

Herein, the term “substantially” refers to variation of less than 10%, unless otherwise noted.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a first radio frequency (“RF”) port;
a first array of first frequency band radiating elements, where each of the first frequency band radiating elements in the first array is coupled to the first RF port; and
a first plurality of metamaterial RF lenses mounted forwardly of the first array, wherein each metamaterial RF lens comprises a plurality of unit cells, where at least two of the unit cells have different metallization patterns,
wherein the unit cells of a first of the metamaterial RF lenses are arranged in rows and columns, and
wherein the unit cells of the first of the metamaterial RF lenses are arranged asymmetrically.

2-6. (canceled)

7. The base station antenna of claim 1, further comprising:
a second RF port; and
a second array of first frequency band radiating elements, where each of the first frequency band radiating elements in the second array is coupled to the second RF port,
wherein the first array and the second array have respective longitudinal axes that each extend in a longitudinal direction, and are spaced apart from each other in a transverse direction that is perpendicular to the longitudinal direction and to a forward direction.

8. The base station antenna of claim 7, wherein the unit cells of the first of the metamaterial RF lenses are arranged asymmetrically about a first longitudinal axis.

9. The base station antenna of claim 7, wherein the unit cells of the first of the metamaterial RF lenses are arranged asymmetrically about a first transverse axis.

10. The base station antenna of claim 7, wherein the unit cells of the first of the metamaterial RF lenses are arranged asymmetrically about both a first longitudinal axis and a first transverse axis.

11. (canceled)

12. The base station antenna of claim 7, wherein the unit cells in a first column of unit cells of the first of the metamaterial RF lenses that is closest to the second array of first frequency band radiating elements are configured to impart a larger average phase change to first frequency band RF radiation incident thereto than are the remaining unit cells of the first of the metamaterial RF lenses.

13-14. (canceled)

15. The base station antenna of claim 7, further comprising:
a third array of second frequency band radiating elements,
wherein the metamaterial RF lens in the first plurality of metamaterial RF lenses are configured to be substantially transparent to RF radiation at the highest frequency in the second frequency band.

16. The base station antenna of claim 1, further comprising a reflector, wherein radiators of the respective first frequency band radiating elements in the first array are positioned forwardly of the reflector, wherein a first subset of the unit cells of a first of the metamaterial RF lenses that overlap the radiators of a first of the first frequency band radiating elements in a forward direction are configured to impart a larger average phase change to first frequency band RF radiation incident thereto than are the remaining unit cells of the first of the metamaterial RF lenses.

17. The base station antenna of claim 1, wherein each unit cell of the first of the metamaterial RF lenses comprises a plurality of arcuate metal traces that define a respective circular ring.

18. The base station antenna of claim 17, wherein at least some of the unit cells of the first of the metamaterial RF lenses comprise a plurality of meandered metal traces.

19. The base station antenna of claim 18, wherein the plurality of meandered metal traces of each of the at least some of the unit cells of the first of the metamaterial RF lenses extend inwardly from the respective circular rings.

20. (canceled)

21. The base station antenna of claim 7, wherein at least some of the unit cells of the first of the metamaterial RF lenses comprise a plurality of meandered metal traces, and wherein the meandered traces of the unit cells in a first column of unit cells of the first of the metamaterial RF lenses that is closest to the second array of first frequency band radiating elements are longer, on average, than are the meandered traces in the remaining unit cells of the first of the metamaterial RF lenses.

22. (canceled)

23. A base station antenna, comprising:
a first radio frequency (“RF”) port;
a first array of first frequency band radiating elements, where each of the first frequency band radiating elements in the first array is coupled to the first RF port;
a first metamaterial RF lens that comprises a plurality of unit cells mounted forwardly of a first of the first frequency band radiating elements in the first array,
a second RF port; and
a second array of first frequency band radiating elements, where each of the first frequency band radiating elements in the second array is coupled to the second RF port,
wherein the unit cells that extend around a periphery of the first metamaterial RF lens are configured, on average, to impart a larger phase change to first frequency band RF radiation incident thereto than are the unit cells that are within the periphery of the first metamaterial RF lens,
wherein the first array and the second array have respective longitudinal axes that extend in a longitudinal direction, and are spaced apart from each other in a transverse direction that is perpendicular to the longitudinal direction,
wherein the unit cells of the first metamaterial RF lens are arranged in a plurality of rows that extend in the transverse direction and in a plurality of columns that extend in the longitudinal direction, and
wherein the unit cells in a first of the plurality of columns that is a closest of the plurality of columns to the second array are configured to, on average, impart a larger phase change to first frequency band RF radiation incident thereto than are the unit cells in a second of the plurality of columns that is a farthest of the plurality of columns from the second array.

24-28. (canceled)

29. The base station antenna of claim 23, wherein the unit cells are arranged asymmetrically about a first longitudinal axis.

30. The base station antenna of claim 23, further comprising a second metamaterial RF lens that comprises a plurality of unit cells mounted forwardly of one of the first frequency band radiating elements in the second array,
wherein the second metamaterial RF lens is identical to the first metamaterial RF lens, and
wherein the second metamaterial RF lens is rotated 180 degrees with respect to the first metamaterial RF lens.

31-35. (canceled)

36. The base station antenna of claim 23, wherein the unit cells in a first column of unit cells of the first metamaterial RF lens that is closest to the second array of first frequency band radiating elements include, on average, more metal than do the remaining unit cells of the first metamaterial RF lens.

37. A base station antenna, comprising:
a first radio frequency (“RF”) port;
a second RF port;
a first array of first frequency band radiating elements, where each of the first frequency band radiating element in the first array is coupled to the first RF port;
a first metamaterial RF lens mounted forwardly of a first of the first frequency band radiating elements in the first array; and
a second array of first frequency band radiating elements, where each of the first frequency band radiating elements in the second array is coupled to the second RF port,
wherein the first metamaterial RF lens is configured to increase isolation between the first array and the second array.

38-39. (canceled)

40. The base station antenna of claim 37, wherein the first metamaterial RF lens comprises a plurality of unit cells, and ones of the unit cells of the first metamaterial RF lens are arranged in a plurality of rows and in a plurality of columns, and wherein the unit cells in a first of the plurality of columns that is a closest of the plurality of columns to the second array are, on average, configured to impart a larger phase change to first frequency band RF radiation incident thereto than are the remaining unit cells of the first metamaterial RF lens.

41-42. (canceled)

43. The base station antenna of claim 37, wherein each unit cell of the first metamaterial RF lens comprises a plurality of arcuate metal traces that define a respective circular ring.

44. The base station antenna of claim 43, wherein at least some of the unit cells of the first metamaterial RF lens comprise a plurality of meandered metal traces.

45. The base station antenna of Claim wherein the plurality of meandered metal traces of each of the at least some of the unit cells of the first metamaterial RF lens extend inwardly from the respective circular rings.

46-51. (canceled)
